(19) United States
(12) Patent Application Publication
(10) Pub. No.: US 2025/0258506 A1
(43) Pub. Date: Aug. 14, 2025

(54) FLOW CONTROL METHOD, STORAGE MEDIUM, AND LIQUID SUBSTANCE TANK APPARATUS

(71) Applicant: Konica Minolta, Inc., Tokyo (JP)

(72) Inventors: Utako TAKAHASHI, Nagaokakyo-shi (JP); Masaru FUSE, Osaka (JP)

(21) Appl. No.: 19/046,077

(22) Filed: Feb. 5, 2025

(30) Foreign Application Priority Data
Feb. 14, 2024 (JP) 2024-019896

(51) Int. Cl. G05D 7/06

(52) U.S. Cl. CPC G05D 7/0617

(57) ABSTRACT

A flow control method in a tank into and from which a liquid substance flows and flows out includes deriving a parameter related to a flow state of the liquid substance as a calculation result, and adjusting a flow range of the liquid substance based on the calculation result.

### CROSS-REFERENCE TO RELATED APPLICATIONS

The entire disclosure of Japanese Patent Application No. 2024-019896 filed on Feb. 14, 2024, is incorporated herein by reference in its entirety.

### BACKGROUND OF THE INVENTION

### Technical Field

The present invention relates to a flow control method, a storage medium, and a liquid substance tank apparatus.

### Description of Related Art

There have been many kinds of manufacturing in which a liquid or a liquid substance is handled during a process or in a step(s) thereof even if a final product is a solid substance, such as a resin product exemplified by plastic. It is considered that in the future, not only in the fields of manufacturing chemical products and composite resin materials having advanced functions, but also in the fields of manufacturing pharmaceutical products, food products, bio-products, and the like, the number of processes using a liquid substance as an intermediate product will increase more and more. Chemical products and composite resin materials having advanced functions include, for example, optical films for liquid crystal panels and carbon fiber reinforced thermoplastics (CFRTP).

Further, there have been increasing social demands for sustainable development goals (SDGs) and the like. Therefore, by reviewing the economic activities of mass production and mass consumption so far, there is a demand for on-demand production that provides “the necessary products and services in the required amounts to the people who need them when they need them”. Therefore, it is expected that an on-demand production style in which a liquid substance is used as a raw material and different kinds of products or different products are switched and manufactured on one line according to a demand will be further expanded in the future.

With the improvement of computer performance as a background, it has become possible to analyze any objects and phenomena by computer simulation. However, it is not easy to visualize a state or characteristics of an object that changes from moment to moment in a manufacturing process. Therefore, in most cases, simulations have been used for determination of conditions for material composition and process parameters in a design stage before start of manufacturing. However, while the style of manufacturing goods is becoming on-demand one, it is conceivable that cases will increase in the future in which determination of conditions by simulation each time products are changed does not pay from the viewpoint of time and cost.

Meanwhile, with the introduction of cloud computing and the like, it is expected that computing capacity will continue to increase dramatically. Therefore, it is expected to improve product quality and production efficiency by, for example, visualizing the state or the like of an object that changes during a manufacturing process and appropriately adjusting the material composition and process parameters on the basis of the result.

In manufacturing, for a process of handling a liquid substance, a stock tank may be provided in which a certain amount of a liquid substance is always reserved for de-foaming or for “stopgap” in a case where a problem occurs during the process. However, even if inflow and outflow of the liquid substance are constantly performed, if the tank has a large volume, the entire contents are not refreshed constantly due to the structure or the like of the tank, and retention occurs in part. The liquid substance staying for a long time becomes a degraded substance or solidifies to be a foreign substance. If such an abnormal substance such as a degraded substance or a foreign substance flows out from the tank, a problem may occur in product quality.

Therefore, prompt replacement of the entire contents of the tank is required from the viewpoints of preventing generation of an abnormal substance to stabilize the quality or promptly switching materials in on-demand production. Meanwhile, once an abnormal substance occurs, it is necessary to control the abnormal substance so as to flow out as little as possible so that production can be maintained and continued without stopping the process. Thus, in order to control the quality of a liquid substance in on-demand production, it is necessary to satisfy both of the requirements, which are contrary to each other.

In Japanese Unexamined Patent Publication No. 2009-237653, there is disclosed a technique of monitoring, in real time, the property or the flow speed of a fluid flowing into and out from a tank in order to achieve automation of quality control of products and suppression of loss in the entire plant. In Japanese Unexamined Patent Publication No. 2007-048144, there is disclosed a technique related to a fluid simulation function which is calculated at intervals close to real time in order to improve accuracy of monitoring control and a function of a training apparatus.

However, although the techniques described in Japanese Unexamined Patent Publication No. 2009-237653 and Japanese Unexamined Patent Publication No. 2007-048144 visualize the internal state of a plant or the like, its purpose is limited to early detection of an abnormality or grasping of a deterioration state, and the techniques cannot realize maintenance or control of production qualities.

The present invention has been made in view of the above-mentioned situations. Objects of the present invention include providing a flow control method, a storage medium storing a program, and a liquid substance tank apparatus that can appropriately control the quality of a liquid substance that flows out from a tank.

### SUMMARY OF THE INVENTION

To achieve at least one of the abovementioned objects, according to an aspect of the present invention, a flow control method reflecting one aspect of the present invention is a flow control method in a tank into and from which a liquid substance flows and flows out, the flow control method including:
deriving a parameter related to a flow state of the liquid substance as a calculation result; and
adjusting a flow range of the liquid substance based on the calculation result.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1A is a diagram illustrating a flow range of a liquid substance in a tank;

FIG. 1B is a diagram illustrating the flow range of the liquid substance in the tank;

FIG. 2 is a flowchart of flow control of an embodiment 1;

FIG. 3 is a block diagram illustrating a functional configuration of a liquid substance tank apparatus used for the flow control in the embodiment 1;

FIG. 4 is a flowchart of the flow control of an embodiment 2;

FIG. 5 is a block diagram illustrating a functional configuration of the liquid substance tank apparatus used for the flow control in the embodiment 2;

FIG. 6 is a schematic diagram illustrating an example of the flow control according to an embodiment 2-1:

FIG. 7 is a schematic diagram illustrating an example of the flow control according to an embodiment 2-2; and

FIG. 8 is a schematic diagram illustrating an example of the flow control according to an embodiment 2-3.

### DETAILED DESCRIPTION

Hereinafter, one or more embodiments of the present invention will be described with reference to the drawings. However, the scope of the invention is not limited to the disclosed embodiments.

The following description explains one or more embodiments of the present invention. The effects and features of one or more embodiments of the present invention will be understood from the following detailed description and the drawings. Note that the following detailed description and the drawings are provided for illustration only, and do not limit the scope of the present disclosure.

The following description describes one or more embodiments of the present disclosure with reference to the drawings. However, the scope of the present disclosure is not limited to the disclosed embodiments.

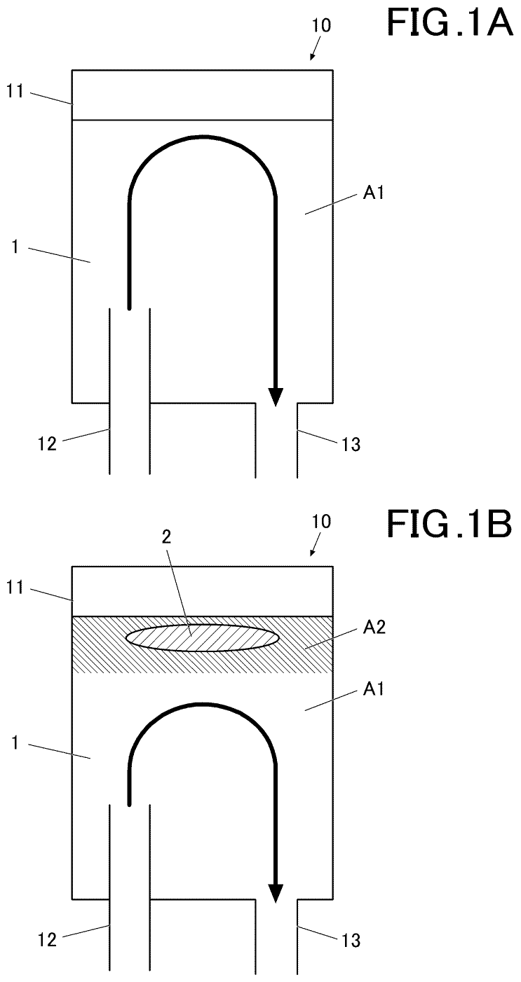

FIG. 1A and FIG. 1B are diagrams illustrating a flow region A1 of a liquid substance 1 in a tank 11.

A flow control method according to the present embodiment is a flow control method in the tank 11 into and from which the liquid substance 1 flows and flows out, and has at least a flow state calculation step and a flow range adjustment step. In the flow control method of the present embodiment, in the flow state calculation step, a parameter related to the flow state of the liquid substance 1 is derived as a calculation result. In the flow control method of the present embodiment, in the flow range adjustment step, the flow range of the liquid substance 1 is adjusted based on the calculation result derived in the flow state calculation step.

In the present embodiment, the expression “based on the calculation result” includes not only a case of being directly based on the calculation result but also a case of being indirectly based on the calculation result, such as based on an abnormality candidate extracted from the calculation result, based on a determination result based on the abnormality candidate, and the like.

The material, size, shape, and the like of the tank 11 are not particularly limited. As illustrated in FIG. 1A and FIG. 1B, the tank 11 constitutes a tank system 10 together with, for example, an inflow section 12 and an outflow section 13. The tank 11 stocks the liquid substance 1 while circulating the liquid substance 1. The inflow section 12 allows the liquid substance 1 to flow into the tank 11. The outflow section 13 allows the liquid substance 1 to flow out from the tank 11. The inflow section 12 and the outflow section 13 are constituted by, for example, pipes.

The liquid substance 1 refers to a substance having flow, such as a liquid. The liquid substance 1 is not limited to a liquid but may be a solution, a dispersion liquid, or the like. The liquid substance 1 may be any of a raw material, an intermediate, a final product, and the like in a manufacturing process of any product.

In the present embodiment, a region in which the contents, which include the liquid substance 1 and an abnormal substance 2, in the tank 11 move with time is referred to as a flow region A1, and a region in which the position of the contents does not change or hardly changes with time is referred to as a residence region A2. A spatial range indicating the flow region A1 is referred to as a flow range. The abnormal substance 2 includes a degraded substance formed by the liquid substance 1 deteriorating, a foreign substance formed by a component contained in the liquid substance 1 solidifying, and the like.

In the flow control method of the present embodiment, for example, the flow range of the liquid substance 1 is adjusted over a wide range to a narrow range in the flow range adjustment step. If the flow range of the liquid substance 1 is adjusted to a wide range, as illustrated in FIG. 1A, the residence region A2 does not exist, or the residence region A2 becomes relatively narrow. Thus, the liquid substance 1 in the tank 11 is promptly replaced, and occurrence of the abnormal substance 2 is reduced. If the flow range of the liquid substance 1 is adjusted to a narrow range, as illustrated in FIG. 1B, the residence region A2 occurs, or the residence region A2 that originally occurs becomes wide. Thus, the abnormal substance 2 that has occurred is appropriately left in the tank 11, so that the outflow (flowing-out) thereof is reduced, or the abnormal substance 2 is allowed to flow out slowly or uniformly without flowing out at once. In the flow control method of the present embodiment, as described above, the flow range can be adjusted based on the calculation result derived in the flow state calculation step. Thus, the quality of the liquid substance 1 flowing out from the tank 11 can be appropriately controlled by a calculation process.

In the flow control method of the present embodiment, in the flow range adjustment step, it is preferable that the flow range of the liquid substance 1 is adjusted to a wide range when the flow state of the liquid substance 1 is normal and to a narrow range when the flow state of the liquid substance 1 is abnormal. Thus, the quality of the liquid substance 1 flowing out from the tank 11 can be more appropriately controlled.

The flow control method of the present embodiment may include a determination step of determining whether the flow state of the liquid substance 1 is normal or abnormal. In this case, in the flow control method of the present embodiment, in the flow range adjustment step, the flow range of the liquid substance 1 may be adjusted only when it is determined in the determination step that the flow state of the liquid substance 1 is abnormal.

### Embodiment 1

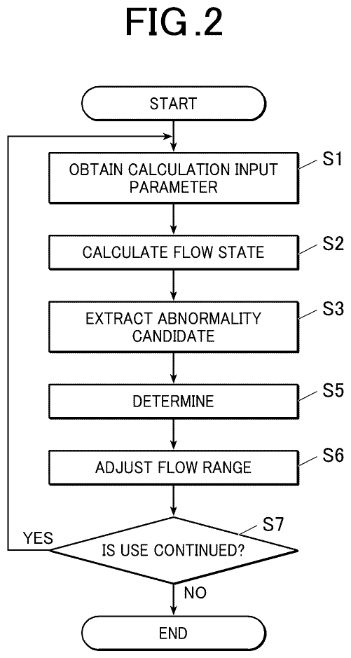

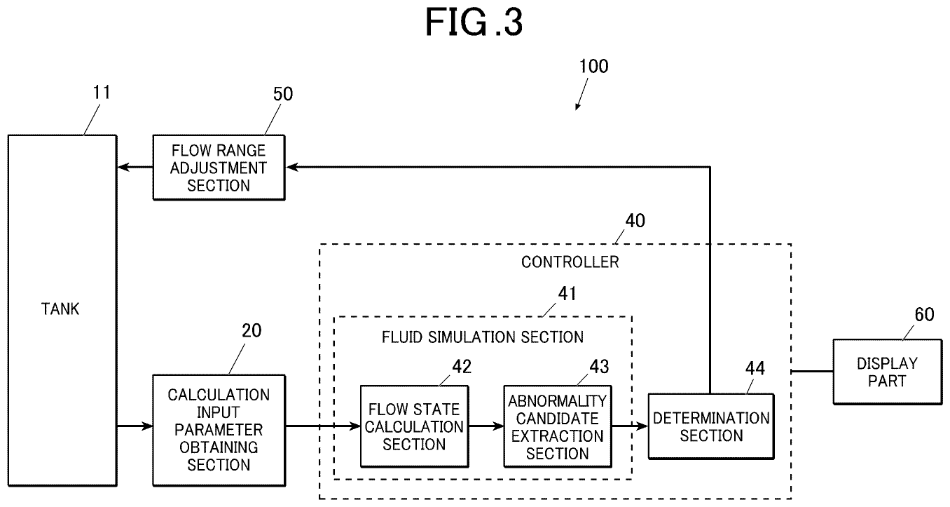

FIG. 2 is a flowchart of flow control according to an embodiment 1 of the present invention. FIG. 3 is a block diagram illustrating a functional configuration of a liquid substance tank apparatus 100 used for flow control in the embodiment 1.

The liquid substance tank apparatus 100 in the embodiment 1 includes a tank system 10, a calculation input parameter obtaining section 20, a controller 40 (hardware processor), a flow range adjustment section 50 (flow range adjuster), and a display part 60.

First, in a calculation input parameter obtaining step (Step S1), the calculation input parameter obtaining section 20 obtain, as a calculation input parameter, a parameter related to the tank 11 and/or a parameter related to the liquid substance 1, the parameters being usable for calculation of the flow state of the liquid substance 1.

Examples of the parameter related to the tank 11 that can be the calculation input parameter include dimensions of the tank 11.

Examples of the parameter related to the liquid substance 1 that can be the calculation input parameter include the temperature, the density, the pressure, the inflow amount, the outflow amount, the inflow speed, the outflow speed, the volume and the viscosity of the liquid substance 1, and the initial position, the size, the density, the viscosity and the temperature of marker particles contained in the liquid substance 1. The calculation input parameter used in the present embodiment may be one parameter or a plurality of parameters.

The marker particles are particles used for calculation of the flow state. The marker particles may be particles originally contained in the liquid substance 1, or may be particles added to the liquid substance 1 for calculation of the flow state.

The calculation input parameter may be an actually measured value or a set value. If the calculation input parameter is an actually measured value, the calculation input parameter obtaining section 20 may be an apparatus or the like that can measure the calculation input parameter. If the calculation input parameter obtaining section 20 is a measurement apparatus, the calculation input parameter obtaining section 20 may be provided in the inflow section 12 or the tank 11. If the calculation input parameter is a set value, the calculation input parameter obtaining section 20 may obtain the set value serving as the calculation input parameter from the outside by, for example, communication, input by a user, or the like.

The liquid substance tank apparatus 100 may include one or a plurality of calculation input parameter obtaining sections 20.

The controller 40 includes a fluid simulation section 41 and a determination section 44 as functional sections. The controller 40 includes, for example, a central processing unit (CPU), a random access memory (RAM), and a read only memory (ROM). The CPU executes various control programs to drive and control the liquid substance tank apparatus 100 and performs various types of arithmetic processing. The RAM provides a working memory space for the CPU and stores temporary data. The RAM may include a nonvolatile memory. The ROM stores various control programs that are executed by the CPU, setting data, and the like. Instead of the ROM, a rewritable nonvolatile memory, such as a flash memory, may be used.

The fluid simulation section 41 includes a flow state calculation section 42 and an abnormality candidate extraction section 43. The fluid simulation section 41 performs a fluid simulation and calculates the flow state of the liquid substance 1 in the tank 11 at any time. Specifically, in the fluid simulation section 41, the flow state calculation section 42 and the abnormality candidate extraction section 43 function as follows.

In the flow state calculation step (Step S2), the flow state calculation section 42 derives the parameter related to the flow state of the liquid substance 1 as a calculation result. It is preferable that the flow state calculation section 42 derives the parameter related to the flow state of the liquid substance 1 as the calculation result on the basis of the calculation input parameter obtained by the calculation input parameter obtaining section 20.

Examples of the parameter relating to the flow state of the liquid substance 1 include the residence time, the residence time distribution, the density distribution, the viscosity distribution, the flow speed distribution, the temperature distribution, the pressure distribution, the marker particle distribution, and the replacement rate. The parameter relating to the flow state of the liquid substance 1 may be one parameter or a plurality of parameters. The parameter relating to the flow state of the liquid substance 1 may be at least one of the residence time and the residence time distribution. The parameter relating to the flow state of the liquid substance 1 may be at least one of the density distribution, the viscosity distribution, the flow speed distribution, the temperature distribution, the pressure distribution, the marker particle distribution, and the replacement rate.

Alternatively, the parameter related to the flow state of the liquid substance 1 may be a two dimensional distribution of scalar values calculated from two or more parameters related to the flow state of the liquid substance 1. This simplifies the calculation result, and the flow control is likely to be performed quickly and appropriately.

The display part 60 displays the calculation result, thereby visualizing the calculation result derived by the flow state calculation section 42. The display part 60 is not particularly limited, but is, for example, a liquid crystal display (LCD). For example, the display part 60 displays the calculation result in real time at any time, so that the user can check the flow state of the liquid substance 1 in real time.

Next, in an abnormality candidate extraction step (Step S3), the abnormality candidate extraction section 43 extracts, as an abnormality candidate(s), the parameter related to the flow state of the liquid substance 1 having a possibility of being abnormal, on the basis of comparison between the calculation result derived by the flow state calculation section 42 and a range set as a target. The calculation result of the parameter related to the flow state of the liquid substance 1 is extracted as an abnormality candidate, for example, when an arbitrary condition set in advance is satisfied (e.g., when a threshold value is exceeded).

Next, in a determination step (Step S5), the determination section 44 determines, based on the abnormality candidate extracted by the abnormality candidate extraction section 43, whether the flow state of the liquid substance 1 is normal or abnormal. In the determination step, for example, two or more abnormality candidates are evaluated on the basis of a preset condition, and it is determined whether the flow state of the liquid substance 1 is normal or abnormal. Note that the preset condition includes the degree of importance of influence of the parameter related to the flow state of the liquid substance 1 on the quality and the like of the final product, the priority order in a cause-and-effect relationship between parameters that determine the quality, and/or the like.

Next, in the flow range adjustment step (Step S6), the flow range adjustment section 50 adjusts an adjustment parameter, thereby adjusting the flow range of the liquid substance 1.

The adjustment parameter is a parameter that affects the flow range of the liquid substance 1 among the parameter(s) related to the liquid substance 1. Examples of the parameter related to the liquid substance 1 that can be the adjustment parameter include the temperature, the density, the pressure, the inflow amount, the outflow amount, the inflow speed, the outflow speed, the volume and the viscosity of the liquid substance 1. The adjustment parameter used in the present embodiment may be one parameter or a plurality of parameters.

In the flow range adjustment step (Step S6), the flow range of the liquid substance 1 may be adjusted in one of the case where the determination result in the determination step is abnormal and the case where the determination result in the determination step is normal, or the flow range of the liquid substance 1 may be adjusted in both of the cases.

In the flow range adjustment step (Step S6), it is preferable that the flow range of the liquid substance 1 is adjusted at least in the case where it is determined in the determination step that the flow state of the liquid substance 1 is abnormal.

If it is determined in the determination step that the flow state of the liquid substance 1 is abnormal, the flow range adjustment section 50 adjusts the flow range of the liquid substance 1 to be, for example, narrower than that at the time. Therefore, even if the abnormal substance 2 occurs, the abnormal substance 2 can be prevented from flowing out by being intentionally caused to stay, or can be caused to flow out slowly or uniformly.

If it is determined in the determination step that the flow state of the liquid substance 1 is normal, the flow range adjustment section 50 adjusts the flow range of the liquid substance 1 to be, for example, wider than that at the time. Therefore, the liquid substance 1 in the tank 11 can be replaced promptly, and occurrence of the abnormal substance 2 can be reduced.

After a lapse of a certain time from the flow range adjustment step (Step S6), In Step S7, the controller 40 determines whether to continue using the liquid substance tank apparatus 100. If it is determined not to continue using the liquid substance tank apparatus 100, the flow control ends. If it is determined to continue using the liquid substance tank apparatus 100, the flow control is performed again starting from the calculation input parameter obtaining step (Step S1).

The controller 40 determines whether to continue using the liquid substance tank apparatus 100, for example, based on whether the outflow amount of the liquid substance 1 has reached a preset amount.

### Embodiment 2

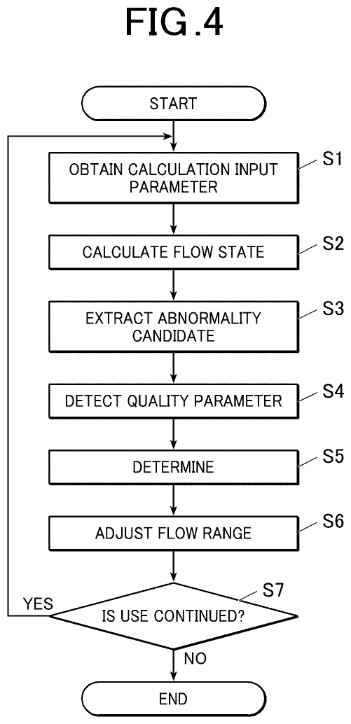

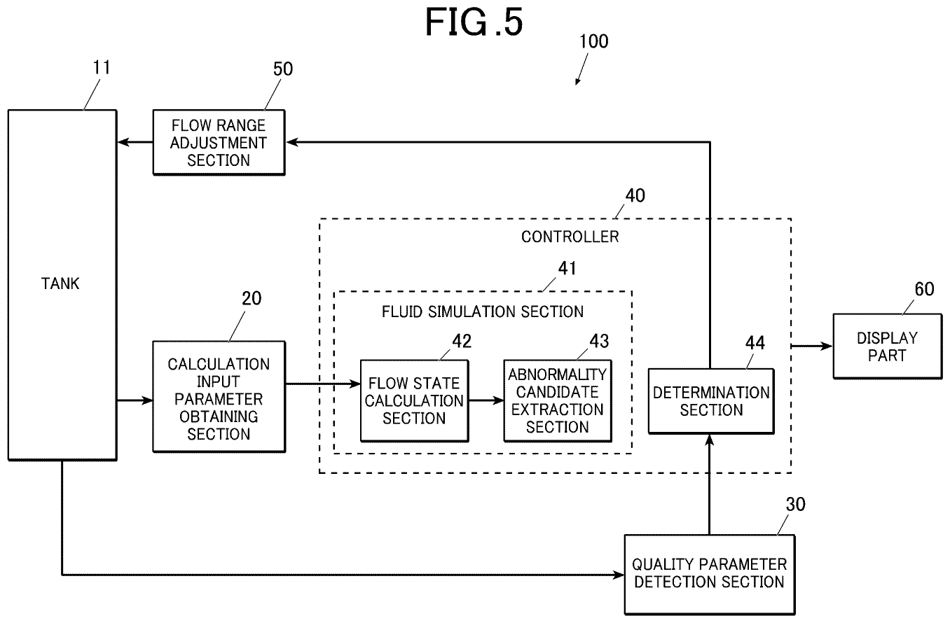

FIG. 4 is a flowchart of the flow control according to an embodiment 2 of the present invention. FIG. 5 is a block diagram illustrating a functional configuration of the liquid substance tank apparatus 100 used for the flow control in the embodiment 2.

The liquid substance tank apparatus 100 in the embodiment 2 includes a tank system 10, a calculation input parameter obtaining section 20, a quality parameter detection section 30, a controller 40, a flow range adjustment section 50, and a display part 60.

The calculation input parameter obtaining step (Step S1), the flow state calculation step (Step S2), and the abnormality candidate extraction step (Step S3) in the embodiment 2 are the same as those in the embodiment 1.

The flow control method according to the embodiment 2 includes a quality parameter detection step (Step S4) after the anomality candidate extraction step (Step S3). In the quality parameter detection step (Step S4), the quality parameter detection section 30 detects a parameter related to the quality of the liquid substance 1 as a quality parameter.

Examples of the quality parameter include temporal changes in the density, the viscosity and the color of the liquid substance 1 in the tank 11 or after flowing out from the tank 11, and presence or absence, the number, the shape, the size and the type of the abnormal substance(s) 2 contained in the liquid substance 1. The quality parameter used in the present embodiment may be one parameter or a plurality of parameters.

The quality parameter detection section 30 is, for example, a sensor. The quality parameter detection section 30 can detect the quality parameter using, for example, at least one of a detector using ultrasonic waves as a detection medium, a detector using electromagnetic waves as a detection medium, a camera, and a colorimeter.

In the determination step (Step S5) in the embodiment 2, the determination section 44 determines whether the flow state of the liquid substance 1 is normal or abnormal, on the basis of the abnormality candidate extracted by the abnormality candidate extraction section 43 and the quality parameter detected by the quality parameter detection section 30. In the determination step, for example, one or more abnormality candidates and one or more quality parameters are evaluated on the basis of a preset condition, and it is determined whether the flow state of the liquid substance 1 is normal or abnormal. Note that the preset condition includes the degree of importance of influence of the parameter related to the flow state of the liquid substance 1 on the quality and the like of the final product, the priority order in a cause-and-effect relationship between parameters that determine the quality, and/or the like. Alternatively, the preset condition includes the degree of match or consistency between the anomality candidate extracted by the abnormality candidate extraction section 43 and the quality parameter detected by the quality parameter detection section 30.

As in the embodiment 1, after the determination step (Step S5), in the flow range adjustment step (Step S6), the flow range adjustment section 50 adjusts the adjustment parameter, thereby adjusting the flow range of the liquid substance 1. The adjustment parameter is, for example, the parameter related to the liquid substance 1 corresponding to the abnormality candidate in the case where the abnormality candidate extracted by the abnormality candidate extraction section 43 and the quality parameter detected by the quality parameter detection section 30 match.

After a lapse of a certain time from the flow range adjustment step (Step S6), In Step S7, the controller 40 determines whether to continue using the liquid substance tank apparatus 100. If it is determined not to continue using the liquid substance tank apparatus 100, the flow control ends. If it is determined to continue using the liquid substance tank apparatus 100, the flow control is performed again starting from the calculation input parameter obtaining step (Step S1).

The flowcharts illustrated in FIG. 2 and FIG. 4 are mere examples, and the flow of the flow control method of the present disclosure is not limited thereto. For example, in the flowchart of FIG. 4, the quality parameter detection step (Step S4) may be performed before Steps S1 to S3, or may be performed simultaneously with Steps S1 to S3.

Next, embodiments 2-1, 2-2 and 2-3 that are specific examples of the embodiment 2 will be described.

### Embodiment 2-1

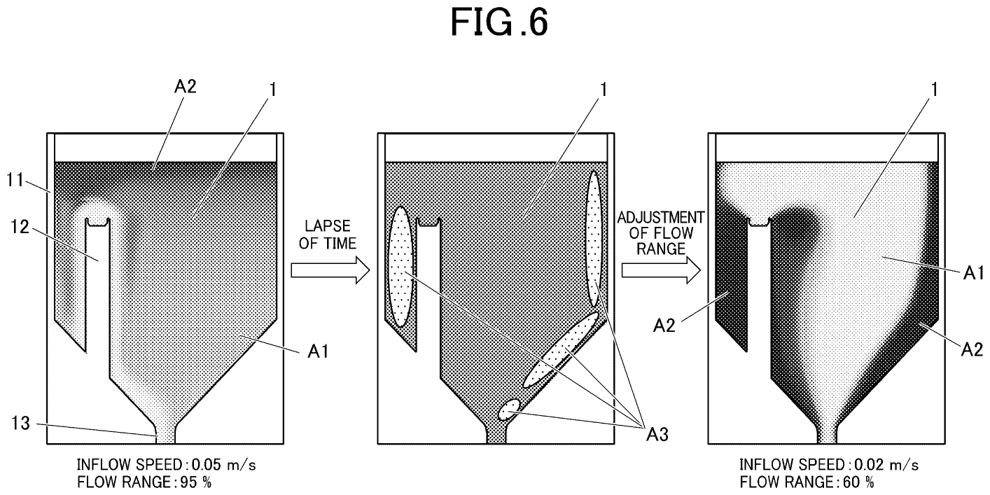

FIG. 6 is a schematic diagram illustrating an example of the flow control according to an embodiment 2-1. In this example, a viscosity increase region A3 occurs after a lapse of a certain time from a state in which the inflow speed is 0.05 m/s and the ratio of the flow range is 95%. In the embodiment 2-1, the viscosity distribution is calculated and derived at any time in real time as the parameter related to the flow state of the liquid substance 1. In the embodiment 2-1, the temporal change in the viscosity of the liquid substance 1 in the tank 11 is detected as the quality parameter. In the anomality candidate extraction step, the viscosity distribution is extracted as an anomality candidate from the calculation result that is the parameter related to the flow state of the liquid substance 1 at the timing at which the viscosity increase region A3 occurs. Next, based on the viscosity distribution as the abnormality candidate and the detected temporal change in the viscosity, if they match or show a certain level of consistency, it is determined that the flow state of the liquid substance 1 is abnormal. Then, in the example illustrated in FIG. 6, the inflow speed is reduced to 0.02 m/s, and the ratio of the flow range is adjusted to 60%, which is a narrower range as compared with 95%. Thus, the region including the viscosity increase region A3 having a high possibility that the abnormal substance 2 is present becomes the residence region A2, and the outflow (flowing-out) of the abnormal substance 2 is reduced. In this example, the inflow speed is used as the adjustment parameter. The embodiment 2-1 is suitably applied, for example, to a case where the liquid substance 1 is a raw material or an intermediate used for a resin product, such as a film whose product thickness changes depending on the viscosity.

### Embodiment 2-2

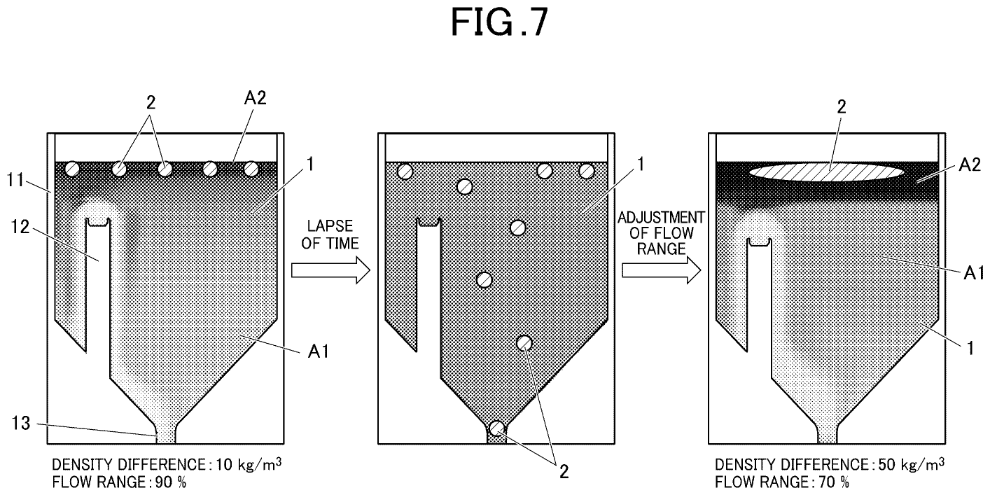

FIG. 7 is a schematic diagram illustrating an example of the flow control according to an embodiment 2-2. In this example, the outflow of the abnormal substance 2 is detected after a certain time elapses from a state in which the density difference between the liquid substance 1 in the tank 11 and the liquid substance 1 to be caused to flow in is 10 kg/m³ and the ratio of the flow range is 90%. In the embodiment 2-2, the marker particle distribution and/or the residence time distribution in the tank 11 are/is calculated and derived at any time in real time as the parameter related to the flow state of the liquid substance 1. Further, in the embodiment 2-2, the temporal change in the number of abnormal substances 2 flowing out is detected as the quality parameter. In the abnormality candidate extraction step, the marker particle distribution and/or the residence time distribution are/is extracted as an abnormality candidate(s) from the calculation result that is the parameter related to the flow state of the liquid substance 1 at the timing at which the abnormal substance 2 flows out. Next, based on the marker particle distribution and/or the residence time distribution as the abnormality candidate(s) and the detected temporal change in the number of abnormal substances 2, if they match or show a certain level of consistency, it is determined that the flow state of the liquid substance 1 is abnormal. Then, in the example illustrated in FIG. 7, the density of the liquid substance 1 to be caused to flow in is increased such that the density difference between the liquid substance 1 in the tank 11 and the liquid substance 1 to be caused to flow in becomes 50 kg/m³, and the ratio of the flow range is adjusted to 70%, which is a narrower range as compared with 90%. Thus, the residence time distribution increases, the residence region A2 occurs at the upper portion in the tank 11, and the abnormal substance 2 is likely to stay in the residence region A2, and therefore the outflow of the abnormal substance 2 is reduced. In this example, the density of the liquid substance 1 to be caused to flow in is used as the adjustment parameter. The embodiment 2-2 is suitably applied to, for example, a case where the liquid substance 1 is a raw material, an intermediate, or a final product of food, cosmetics, medicine or the like for which presence or absence of the abnormal substance 2 is a main factor of the product quality.

### Embodiment 2-3

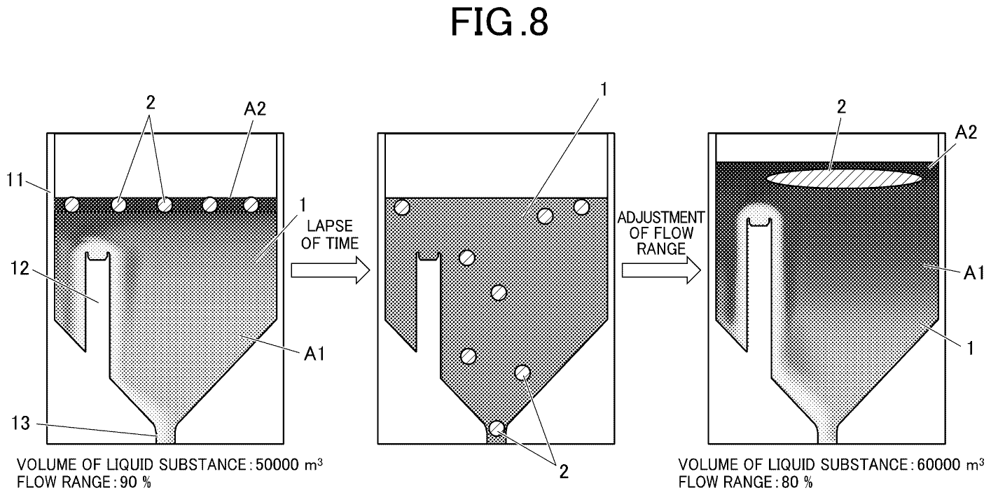

FIG. 8 is a schematic diagram illustrating an example of the flow control according to an embodiment 2-3. In this example, the outflow of the abnormal substance 2 is detected after a certain time elapses from a state in which the volume of the liquid substance 1 in the tank 11 is 50,000 m³ and the ratio of the flow range is 90%. In the embodiment 2-3, as in the embodiment 2-2, the marker particle distribution and/or the residence time distribution in the tank 11 are/is calculated and derived at any time in real time as the parameter related to the flow state of the liquid substance 1. Further, in the embodiment 2-3, the temporal change in the number of abnormal substances 2 flowing out is detected as the quality parameter. In the abnormality candidate extraction step, the marker particle distribution and/or the residence time distribution are/is extracted as an abnormality candidate(s) from the calculation result that is the parameter related to the flow state of the liquid substance 1 at the timing at which the abnormal substance 2 flows out. Next, based on the marker particle distribution and/or the residence time distribution as the abnormality candidate(s) and the detected temporal change in the number of abnormal substances 2, it is determined that the flow state of the liquid substance 1 is abnormal. Then, in the example shown in FIG. 8, the inflow amount of the liquid substance 1 is reduced such that the volume of the liquid substance 1 in the tank 11 becomes 60,000 m³, and the ratio of the flow range is adjusted to 80%, which is a narrower range as compared with 90%. Thus, the residence time distribution increases, the residence region A2 occurs at the upper portion in the tank 11, and the abnormal substance 2 is likely to stay in the residence region A2, and therefore the outflow of the abnormal substance 2 is reduced. In this example, the inflow amount of the liquid substance 1 is used as the adjustment parameter. Similarly to the embodiment 2-2, the embodiment 2-3 is suitably applied to, for example, the case where the liquid substance 1 is a raw material, an intermediate, or a final product of foods, cosmetics, medicine or the like for which presence or absence of the abnormal substance 2 is a main factor of the product quality.

As described above, the flow control method of the present disclosure is a flow control method in a tank into and from which a liquid substance flows and flows out and includes a flow state calculation step and a flow range adjustment step. In the flow control method of the present disclosure, in the flow state calculation step, a parameter related to the flow state of the liquid substance is derived as a calculation result. In the flow control method of the present disclosure, in the flow range adjustment step, the flow range of the liquid substance is adjusted based on the calculation result derived in the flow state calculation step. Thus, the flow control method of the present disclosure can appropriately control the quality of the liquid substance flowing out from the tank.

The program of the present disclosure is a program that causes, of a liquid substance tank apparatus including a tank into and from which a liquid substance flows and flows out, a computer to function as a controller (hardware processor) that performs a flow state calculation step and a flow range adjustment step. In the flow state calculation step, the controller derives a parameter related to the flow state of the liquid substance as a calculation result. In the flow range adjustment step, the controller adjusts the flow range of the liquid substance based on the calculation result derived in the flow state calculation step.

The liquid substance tank apparatus of the present disclosure is a liquid substance tank apparatus including a tank into and from which a liquid substance flows and flows out, a flow state calculation section, and a flow range adjustment section. The flow state calculation section derives a parameter related to the flow state of the liquid substance as a calculation result. The flow range adjustment section adjusts the flow range of the liquid substance based on the calculation result derived by the flow state calculation section.

In the above, one or more embodiments of the present invention have been described and illustrated in detail. The disclosed embodiments are for purposes of illustration and example only, and are not intended to be limitations. The scope of the present disclosure should be interpreted by the terms of claims.

Although embodiments of the present invention have been described and illustrated in detail, the disclosed embodiments are made for purposes of illustration and example only and not limitation. The scope of the present invention should be interpreted by terms of the appended claims.

What is claimed is:

1. A flow control method in a tank into and from which a liquid substance flows and flows out, the flow control method comprising:
deriving a parameter related to a flow state of the liquid substance as a calculation result; and
adjusting a flow range of the liquid substance based on the calculation result.

2. The flow control method according to claim 1, further comprising detecting a parameter related to a quality of the liquid substance as a quality parameter,
wherein the adjusting includes adjusting the flow range of the liquid substance based on the calculation result and the quality parameter.

3. The flow control method according to claim 1, further comprising obtaining, as a calculation input parameter, a parameter related to the tank and/or a parameter related to the liquid substance, the parameters being usable for calculation of the flow state of the liquid substance,
wherein the deriving includes deriving the calculation result based on the calculation input parameter,
wherein the flow control method further comprises:
extracting, as an abnormality candidate, the parameter related to the flow state of the liquid substance having a possibility of being abnormal, based on comparison between the calculation result and a range set as a target; and
determining based on the abnormality candidate whether the flow state of the liquid substance is normal or abnormal, and
wherein the adjusting includes, in response to determining that the flow state of the liquid substance is abnormal, adjusting the flow range of the liquid substance by adjusting, as an adjustment parameter, the parameter related to the liquid substance and affecting the flow range of the liquid substance.

4. The flow control method according to claim 2, further comprising obtaining, as a calculation input parameter, a parameter related to the tank and/or a parameter related to the liquid substance, the parameters being usable for calculation of the flow state of the liquid substance,
wherein the deriving includes deriving the calculation result based on the calculation input parameter,
wherein the flow control method further comprises:
extracting, as an abnormality candidate, the parameter related to the flow state of the liquid substance having a possibility of being abnormal, based on comparison between the calculation result and a range set as a target; and
determining based on the abnormality candidate and the quality parameter whether the flow state of the liquid substance is normal or abnormal, and
wherein the adjusting includes, in response to determining that the flow state of the liquid substance is abnormal, adjusting the flow range of the liquid substance by adjusting, as an adjustment parameter, the parameter related to the liquid substance and affecting the flow range of the liquid substance.

5. The flow control method according to claim 1, wherein the calculation result is one or more of a residence time and a residence time distribution.

6. The flow control method according to claim 1, wherein the calculation result is one or more of a density distribution, a viscosity distribution, a flow speed distribution, a temperature distribution, a pressure distribution, a marker particle distribution, and a replacement rate.

7. The flow control method according to claim 3, wherein the calculation input parameter is one or more of a temperature of the liquid substance, a density of the liquid substance, a pressure of the liquid substance, an inflow amount of the liquid substance, an outflow amount of the liquid substance, an inflow speed of the liquid substance, an outflow speed of the liquid substance, a volume of the liquid substance, a viscosity of the liquid substance, a dimension of the tank, an initial position of a marker particle contained in the liquid substance, a size of the marker particle, a density of the marker particle, a viscosity of the marker particle, and a temperature of the marker particle.

8. The flow control method according to claim 2, wherein the quality parameter is a temporal change in one or more of a density of the liquid substance in the tank or after flowing out from the tank, a viscosity of the liquid substance, and a color of the liquid substance, presence or absence of an abnormal substance contained in the liquid substance, a number of the abnormal substance, a shape of the abnormal substance, a size of the abnormal substance, and a type of the abnormal substance.

9. The flow control method according to claim 2, wherein the detecting includes detecting the quality parameter using one or more of a detector using an ultrasonic wave as a detection medium, a detector using an electromagnetic wave as a detection medium, a camera, and a colorimeter.

10. The flow control method according to claim 1, wherein the adjusting includes adjusting the flow range of the liquid substance over a wide range to a narrow range.

11. The flow control method according to claim 10, wherein the adjusting includes adjusting the flow range of the liquid substance to a wide range in response to determining that the flow state of the liquid substance is normal and adjusting the flow range of the liquid substance to a narrow range in response to determining that the flow state of the liquid substance is abnormal.

12. The flow control method according to claim 11,
wherein the adjusting includes adjusting the flow range of the liquid substance by adjusting, as an adjustment parameter, a parameter related to the liquid substance and affecting the flow range of the liquid substance, and
wherein the adjustment parameter is one or more of a temperature of the liquid substance, a density of the liquid substance, a pressure of the liquid substance, an inflow amount of the liquid substance, an outflow amount of the liquid substance, an inflow speed of the liquid substance, an outflow speed of the liquid substance, a volume of the liquid substance, and a viscosity of the liquid substance.

13. The flow control method according to claim 1, wherein the calculation result is visualized.

14. A non-transitory computer-readable storage medium storing a program causing, of a liquid substance tank apparatus including a tank into and from which a liquid substance flows and flows out, a computer to perform:
deriving a parameter related to a flow state of the liquid substance as a calculation result; and
adjusting a flow range of the liquid substance based on the calculation result.

15. A liquid substance tank apparatus comprising:
a tank into and from which a liquid substance flows and flows out;
a hardware processor that derives a parameter related to a flow state of the liquid substance as a calculation result; and
a flow range adjuster that adjusts a flow range of the liquid substance based on the calculation result.
